(19) United States
(12) Patent Application Publication
(10) Pub. No.: US 2011/0292438 A1
(43) Pub. Date: Dec. 1, 2011

(54) IMAGE READING APPARATUS, INFORMATION PROCESSING APPARATUS, IMAGE PROCESSING METHOD, AND COMPUTER PROGRAM PRODUCT

(75) Inventors: Yasuharu INAMI, Ishikawa (JP); Kiichi TANIHO, Ishikawa (JP); Mutsumu NAGASHIMA, Ishikawa (JP)

(73) Assignee: PFU LIMITED, Ishikawa (JP)

(21) Appl. No.: 12/915,658

(22) Filed: Oct. 29, 2010

(30) Foreign Application Priority Data
May 26, 2010 (JP) 2010-120848

(51) Int. Cl. G06F 3/12

(52) U.S. Cl. 358/1.15

(57) ABSTRACT

An image reading apparatus includes an image reading unit, a touch panel, a storage unit, and a control unit, wherein the storage unit includes a storage-location-information storage unit that stores storage location information related to a storage location of an image file of a document read by the image reading unit, and the control unit includes an image displaying unit that displays a storage location icon representing the storage location and an image display area showing the image file, a display mode changing unit that changes, when an image selection instruction to select the image file is input, a display mode of the image display area so that the storage location icon can be viewed, and a storing unit that stores, when an icon selection instruction to select the storage location icon is input, the image file in the storage location corresponding to the storage location icon.

### BACKGROUND OF THE INVENTION

1. Field of the Invention

The present invention relates to an image reading apparatus, an information processing apparatus, an image processing method, and a computer program product.

2. Description of the Related Art

In conventional image processing apparatuses, a read image is displayed and then moved to an edit area or a storage destination by a touch operation, such as drag and drop, by a user.

For example, in a document reading apparatus disclosed in JP-A-2008-236539, the read image and the edit area or the storage destination are displayed by being laid out in an aligned manner on a display area of a touch panel. In the document reading apparatus, a technology is disclosed in which print setting, image storing, or the like is performed by user's drag and drop of an icon representing the read image onto the edit area on the touch panel.

In a network scanner apparatus disclosed in Japanese Patent No. 4,272,015, a technology is disclosed in which image data processing conditions (file format, resolution, and the like) of read data, a destination, a file name, and the like are input by using an icon or a touch key on an operation panel made up of a touch panel.

In a document reading apparatus disclosed in JP-A-2008-301502, a technology is disclosed in which a list of a predetermined number of reduced images of documents read by an image reading unit is displayed on a displaying unit, a user is allowed to select a document to be re-read, and the an image of the re-read document is displayed such that the image of the re-read document is superimposed on the image of the previously-read document with shift of the images from each other.

In an electronic document processing apparatus disclosed in JP-A-2007-42092, a technology is disclosed in which searched electronic documents are displayed in a tile view and a user is allowed to drag and drop, via a GUI (Graphic User Interface), an electronic document to add it to a binder displayed in parallel, so that a binder document is generated. Furthermore, in the electronic document processing apparatus, another technology is disclosed in which an electronic document is converted into the same format as the binder document so that the binder document can appropriately be stored, printed, viewed, and managed.

However, in the conventional image processing apparatuses disclosed in JP-A-2008-236539, JP-A-2008-301502, and JP-A-2007-42092, because a window for displaying thumbnail images and a window for displaying a list of icons for defining image processing, such as a storage destination, are displayed side-by-side, there is a problem in that when a touch panel screen is small, the amount of displayable information is reduced, reducing operability.

In the conventional image processing apparatus disclosed in Japanese Patent No. 4,272,015, when processing on an image is specified, display is switched to a totally different screen or pop-up display appears so as to cover a document screen, so that there is a problem in that a user cannot intuitively and continuously perform operations.

### SUMMARY OF THE INVENTION

It is an object of the present invention to at least partially solve the problems in the conventional technology.

An image reading apparatus according to one aspect of the present invention includes an image reading unit, a touch panel, a storage unit, and a control unit, wherein the storage unit includes a storage-location-information storage unit that stores storage location information related to a storage location of an image file of a document read by the image reading unit, and the control unit includes an image displaying unit that displays, on the touch panel, a storage location icon representing the storage location and an image display area showing the image file, a display mode changing unit that changes, when an image selection instruction to select the image file is input via the touch panel, a display mode of the image display area so that the storage location icon can be viewed, and a storing unit that stores, when an icon selection instruction to select the storage location icon is input via the touch panel, the image file in the storage location corresponding to the storage location icon.

An information processing apparatus connected to an image reading apparatus, according to another aspect of the present invention, the information processing apparatus includes a touch panel, a storage unit, and a control unit, wherein the storage unit includes a storage-location-information storage unit that stores storage location information related to a storage location of an image file of a document read by the image reading unit, and the control unit includes an image displaying unit that displays, on the touch panel, a storage location icon representing the storage location and an image display area showing the image file, a display mode changing unit that changes, when an image selection instruction to select the image file is input via the touch panel, a display mode of the image display area so that the storage location icon can be viewed, and a storing unit that stores, when an icon selection instruction to select the storage location icon via the touch panel, the image file in the storage location corresponding to the storage location icon.

An image processing method according to still another aspect of the present invention is executed by an image reading apparatus including an image reading unit, a touch panel, a storage unit, and a control unit, wherein the storage unit includes a storage-location-information storage unit that stores storage location information related to a storage location of an image file of a document read by the image reading unit, the method including an image displaying step of displaying, on the touch panel, a storage location icon representing the storage location and an image display area showing the image file, a display mode changing step of changing, when an image selection instruction to select the image file is input via the touch panel, a display mode of the image display area so that the storage location icon can be viewed, and a storing step of storing, when an icon selection instruction to select the storage location icon is input via the touch panel, the image file in the storage location corresponding to the storage location icon, wherein the steps are executed by the control unit.

An image processing method according to still another aspect of the present invention is executed by an information processing apparatus connected to an image reading apparatus, wherein the information processing apparatus includes a touch panel, a storage unit, and a control unit, wherein the storage unit includes a storage-location-information storage unit that stores storage location information related to a storage location of an image file of a document read by the image reading unit, the method including an image displaying step of displaying, on the touch panel, a storage location icon representing the storage location and an image display area showing the image file, a display mode changing step of changing, when an image selection instruction to select the image file is input via the touch panel, a display mode of the image display area so that the storage location icon can be viewed, and a storing step of storing, when an icon selection instruction to select the storage location icon is input via the touch panel, the image file in the storage location corresponding to the storage location icon, wherein the steps are executed by the control unit.

A computer program product having a computer readable medium according to still another aspect of the present invention includes programmed instructions for an image processing method executed by an image reading apparatus including an image reading unit, a touch panel, a storage unit, and a control unit, wherein the storage unit includes a storage-location-information storage unit that stores storage location information related to a storage location of an image file of a document read by the image reading unit, the instructions, when executed by a computer, cause the computer to execute an image displaying step of displaying, on the touch panel, a storage location icon representing the storage location and an image display area showing the image file, a display mode changing step of changing, when an image selection instruction to select the image file is input via the touch panel, a display mode of the image display area so that the storage location icon can be viewed, and a storing step of storing, when an icon selection instruction to select the storage location icon is input via the touch panel, the image file in the storage location corresponding to the storage location icon, wherein the steps are executed by the control unit.

A computer program product having a computer readable medium according to still another aspect of the present invention includes programmed instructions for an image processing method executed by an information processing apparatus connected to an image reading apparatus, wherein the information processing apparatus includes an image reading unit, a touch panel, a storage unit, and a control unit, wherein the storage unit includes a storage-location-information storage unit that stores storage location information related to a storage location of an image file of a document read by the image reading unit, the instructions, when executed by a computer, cause the computer to execute an image displaying step of displaying, on the touch panel, a storage location icon representing the storage location and an image display area showing the image file, a display mode changing step of changing, when an image selection instruction to select the image file is input via the touch panel, a display mode of the image display area so that the storage location icon can be viewed, and a storing step of storing, when an icon selection instruction to select the storage location icon is input via the touch panel, the image file in the storage location corresponding to the storage location icon, wherein the steps are executed by the control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart of a basic principle of an embodiment;

FIG. 2 is a block diagram of an example of a configuration of an image reading apparatus to which the embodiment is applied;

FIG. 3 is a flowchart of an example of processing performed by the image reading apparatus according to the embodiment;

FIG. 4 is a diagram of an example of a display screen according to the embodiment;

FIG. 5 is a diagram of an example of the display screen according to the embodiment;

FIG. 6 is a diagram of an example of the display screen according to the embodiment;

FIG. 7 is a diagram of an example of the display screen according to the embodiment;

FIG. 8 is a diagram of an example of the display screen according to the embodiment; and

FIG. 9 is a diagram of an example of the display screen according to the embodiment.

### DETAILED DESCRIPTION OF THE PREFERRED EMBODIMENTS

An embodiments of an image reading apparatus, an information processing apparatus, an image processing method, and a computer program product according to the present invention will be explained in detail below based on the drawings. The embodiment does not limit the invention.

[Outline of the Embodiment of the Present Invention]

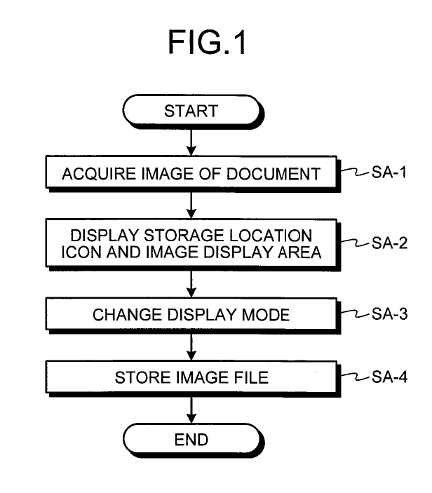

The outline of an embodiment of the present invention is explained below with reference to FIG. 1, and thereafter, configurations, processing, and the like of the embodiment are explained in detail. FIG. 1 is a flowchart of a basic principle of the embodiment.

The embodiment has following basic features in general. That is, as shown in FIG. 1, a control unit of an image reading apparatus according to the embodiment acquires an image file of a document read by an image reading unit (Step SA-1).

Then, the control unit of the image reading apparatus displays on a touch panel a storage location icon representing a storage location stored in a storage unit, and an image display area showing the image file acquired at Step SA-1 (Step SA-2).

When a user inputs an image selection instruction to select an image file via the touch panel, the control unit of the image reading apparatus changes a display mode of the image display area so that the storage location icon can be viewed (Step SA-3).

When the user inputs an icon selection instruction to select the storage location icon via the touch panel, the control unit of the image reading apparatus stores the image file in a storage location stored in the storage unit corresponding to the storage location icon (Step SA-4).

[Configuration of an Image Reading Apparatus]

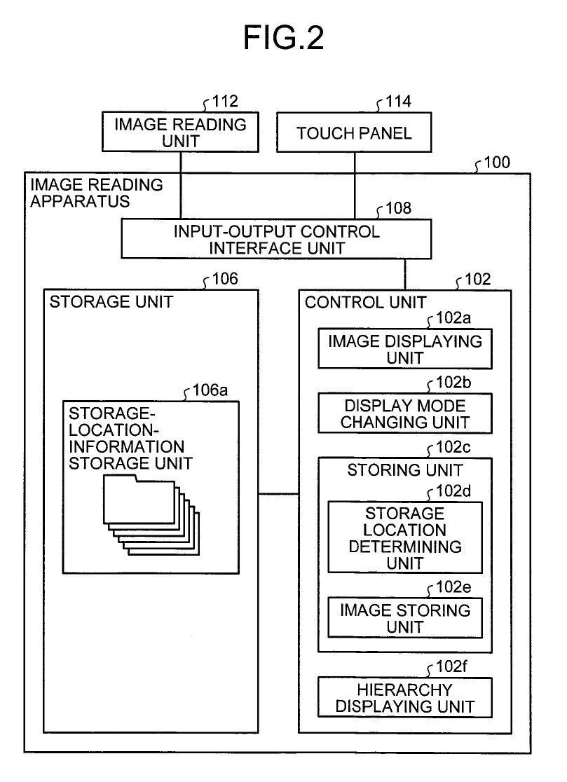

The configuration of the image reading apparatus 100 is explained below with reference to FIG. 2. FIG. 2 is a block diagram of an example of a configuration of the image reading apparatus 100 to which the embodiment is applied, and schematically shows only parts related to the present invention.

In FIG. 2, an image reading apparatus 100 generally includes a control unit 102, an input-output control interface unit 108, a storage unit 106, an image reading unit 112, and a touch panel 114. The control unit 102 is a CPU (Central Processing Unit) or the like that performs overall control on the whole image reading apparatus 100. The input-output control interface unit 108 is an interface connected to the image reading unit 112 and the touch panel 114. The storage unit 106 is a device for storing various databases, tables, or the like. Each unit of the image reading apparatus 100 is communicably connected to one another via any communication channels. Furthermore, the image reading apparatus 100 may be communicably connected to a network via a communication device, such as a router, and a wired communication line or a wireless communication means such as a dedicated line.

The various databases and tables (a storage-location-information storage unit 106a) stored in the storage unit 106 are storage unit such as fixed disk devices. For example, the storage unit 106 stores therein various programs, tables, files, databases, web pages, and the like used in various processing.

Among the components included in the storage unit 106, the storage-location-information storage unit 106a is a storage-location-information storage unit that stores storage location information related to a storage location of an image file of a document read by the image reading unit 112. Here, the storage location is a location for sorting and organizing data, such as files, on a computer, and may be, for example, a cabinet, a drawer, a binder, a folder, a directory, or the like.

In a storage unit of an information processing apparatus to which the embodiment is applied, the storage location of the image file of the document read by the image reading apparatus 100 is set.

In FIG. 2, the input-output control interface unit 108 controls the image reading unit 112 and the touch panel 114. A scanner, a digital camera, a web camera, or the like can be used as the image reading unit 112.

In FIG. 2, the control unit 102 includes an internal memory for storing a control program such as an OS (Operating System), programs that define various processing procedures, and necessary data. The control unit 102 performs information processing for executing various processing by these programs or the like. The control unit 102 functionally and conceptually includes an image displaying unit 102a, a display mode changing unit 102b, a storing unit 102c, and a hierarchy displaying unit 102f.

Among these units, the image displaying unit 102a is an image displaying unit that displays, on the touch panel 114, a storage location icon representing the storage location and an image display area showing an image file. The image displaying unit 102a may display, on the touch panel 114, when a superimposition instruction to superimpose the image file onto any other image file is input via the touch panel 114, the storage location icon and the image display area, wherein the image files are displayed in an aggregated manner. The superimposition instruction may be given by a drag and drop operation of an image file onto any other image file displayed on the touch panel 114. Furthermore, the image displaying unit 102a may display, on the touch panel 114, when an aggregation display instruction to display an aggregation view of image files being displayed as a list is input via the touch panel 114, the storage location icon and the image display area, wherein the image files having been displayed as a list are displayed in an aggregated manner. The aggregation display instruction may be given by an operation, e.g., a tap operation, of selecting an aggregation display instruction icon that represents the aggregation display instruction and that is displayed on the touch panel 114. Moreover, the image displaying unit 102a may display, on the touch panel 114, when a list display instruction to display a list view of image files being displayed in an aggregated manner is input via the touch panel 114, the storage location icon and the image display area, wherein the image files having been displayed in an aggregated manner is displayed as a list. The list display instruction may be given by an operation, e.g., a tap operation, of selecting a list display instruction icon that represents the list display instruction and that is displayed on the touch panel 114. Furthermore, the image displaying unit 102a may display on the touch panel 114 the image display area showing an index image (e.g., a thumbnail, a reduced image, a file name, or an icon) representing an image file in such a manner that the image display area is superimposed on the storage location icon representing the storage location.

The display mode changing unit 102b is a display mode changing unit that changes, when an image selection instruction to select the image file is input via the touch panel 114, a display mode of the image display area so that the storage location icon can be viewed. The image selection instruction may be given by a drag operation of the image file onto the storage location icon. Furthermore, when the image selection instruction to select the image file is input via the touch panel 114, the display mode changing unit 102b translucently may display the image display area. Moreover, when the image selection instruction to select the image file is input via the touch panel 114, the display mode changing unit 102b may display the image display area by moving the image display area based on an input position of the image selection instruction on the touch panel 114 to a position not overlapping a display of the storage location icon at the input position. Furthermore, when the image selection instruction to select the image file is input via the touch panel 114, the display mode changing unit 102b may change the image display area to a minimized icon, and display the minimized icon.

The storing unit 102c is a storing unit that stores, when an icon selection instruction to select the storage location icon is input via the touch panel 114, the image file in the storage location corresponding to the storage location icon. The icon selection instruction may be given by a selection maintaining operation of the image file on the storage location icon. Furthermore, as shown in FIG. 2, the storing unit 102c includes a storage location determining unit 102d and an image storing unit 102e.

The storage location determining unit 102d is a storage location determining unit that determines, when the icon selection instruction to select the storage location icon is input via the touch panel 114, a storage location of the image file. The image storing unit 102e is an image storing unit that stores, when a storing instruction for the image file is input via the touch panel 114, the image file in the storage location determined by the storage location determining unit 102d. The storing instruction may be given by a drop operation of the image file onto the storage location icon.

The hierarchy displaying unit 102f is a hierarchy displaying unit that displays, when an additional storage location is present in a hierarchy under the storage location determined by the storage location determining unit 102d, a storage location icon representing the additional storage location on the touch panel 114.

[Processing Performed by the Image Reading Apparatus 100]

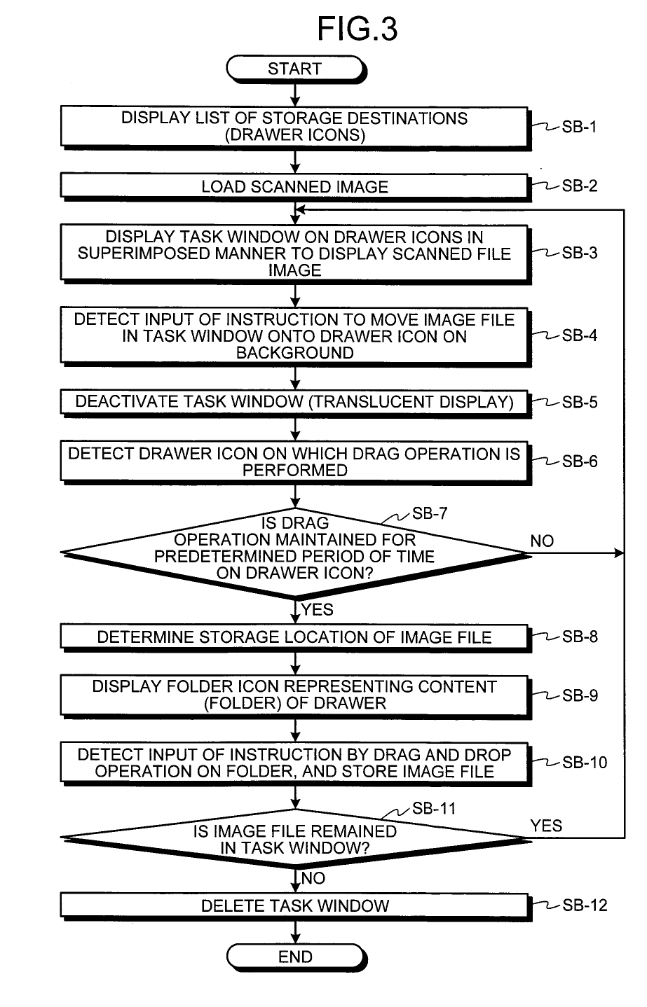

An example of processing performed by the image reading apparatus 100 having the above configuration according to the embodiment is explained in detail below with reference to FIGS. 3 to 8. FIG. 3 is a flowchart of an example of processing performed by the image reading apparatus 100 according to the embodiment.

As shown in FIG. 3, the image displaying unit 102a displays on the touch panel 114 a list of storage location icons (drawer icons 1) representing storage locations (drawers) that is stored in the storage-location-information storage unit 106a and that are storage destinations of an image file of a document read by the image reading unit 112 (Step SB-1).

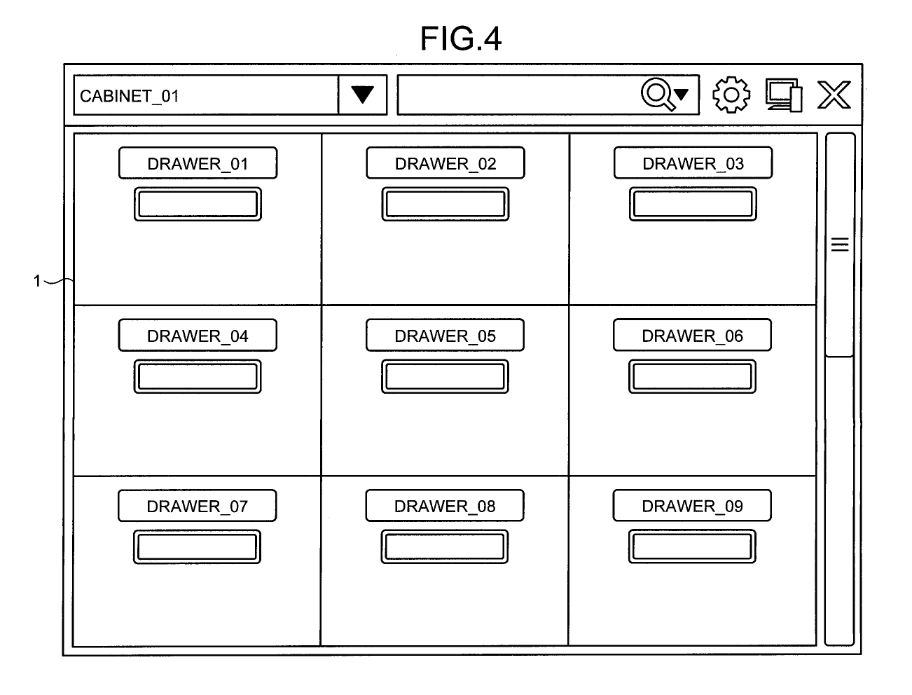

An example of the storage location icons displayed on the touch panel 114 according to the embodiment is explained below with reference to FIG. 4. FIG. 4 is a diagram of an example of a display screen according to the embodiment.

As shown in FIG. 4, the image displaying unit 102a displays on the touch panel 114 a background that is an image of a physical cabinet that is set in the storage-location-information storage unit 106a for enabling to sort and store scanned images. The background being the image of a physical cabinet may be a drawer, a binder, or the like. Specifically, the image displaying unit 102a displays on the touch panel 114 the drawer icons 1 (drawer_01 to drawer_09) that are images of nine drawers in total in a matrix of three columns and three rows.

Referring back to FIG. 3, the control unit 102 loads the image file of the document scanned by the image reading unit 112 (Step SB-2).

The image displaying unit 102a displays an image display area (a task window 2) showing the image file of the document scanned by the image reading unit 112 on the drawer icons 1 on the touch panel 114 in a superimposed manner (Step SB-3).

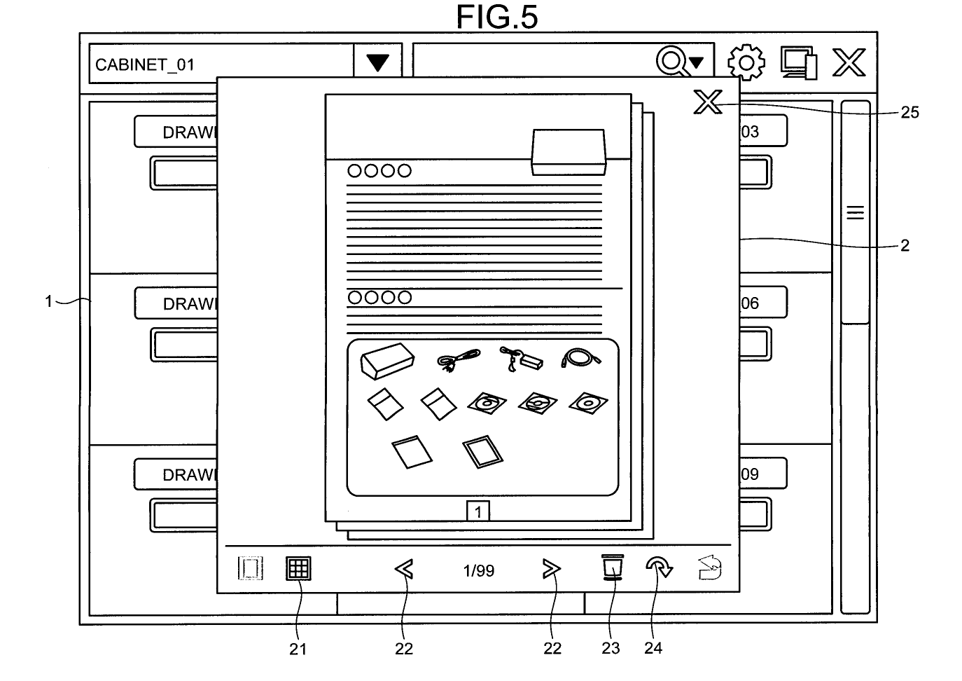

An example of the task window 2 displayed on the touch panel 114 according to the embodiment is explained below with reference to FIGS. 5 to 7. FIGS. 5 to 7 are diagrams of examples of the display screen according to the embodiment.

As shown in FIG. 5, the image displaying unit 102a displays the task window 2 on the drawer icons 1, and then displays on the task window 2 an overlapping image in which a plurality of image files scanned by the image reading unit 112 are aggregated. As shown in FIG. 5, a list display instruction icon 21 for displaying a list of image files, a display change icon 22 for changing an image file displayed at the frontmost to any other image file, a trash box icon 23 for deleting an image file, a rotation icon 24 for rotating an image file, and a close icon 25 for closing the task window 2 are displayed on the task window 2.

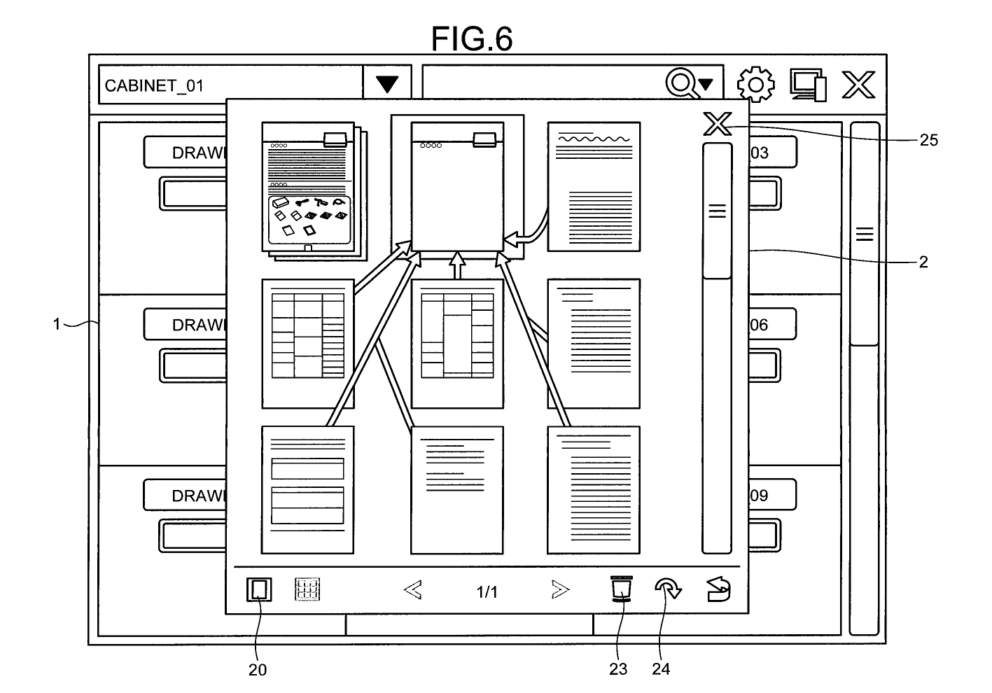

When a user performs (with a finger) a tap operation of the list display instruction icon 21 displayed on the task window 2 via the touch panel 114, the image displaying unit 102a detects the list display instruction on the image files scanned by the image reading unit 112. Then, as shown in FIG. 6, the image displaying unit 102a displays on the drawer icons 1 the task window 2 in which a list of thumbnails of the image files is displayed in a tile view. As shown in FIG. 6, an aggregation display instruction icon 20 for displaying the image files in an aggregated manner and a scroll bar are further displayed on the task window 2.

As shown in FIG. 6, when the user performs (with a finger) a tap operation of the aggregation display instruction icon 20 displayed on the touch panel 114 via the touch panel 114, the image displaying unit 102a detects the aggregation display instruction on the image files. Then, as shown in FIG. 5, the image displaying unit 102a displays on the drawer icons 1 the task window 2 in which the image files are displayed in an aggregated manner.

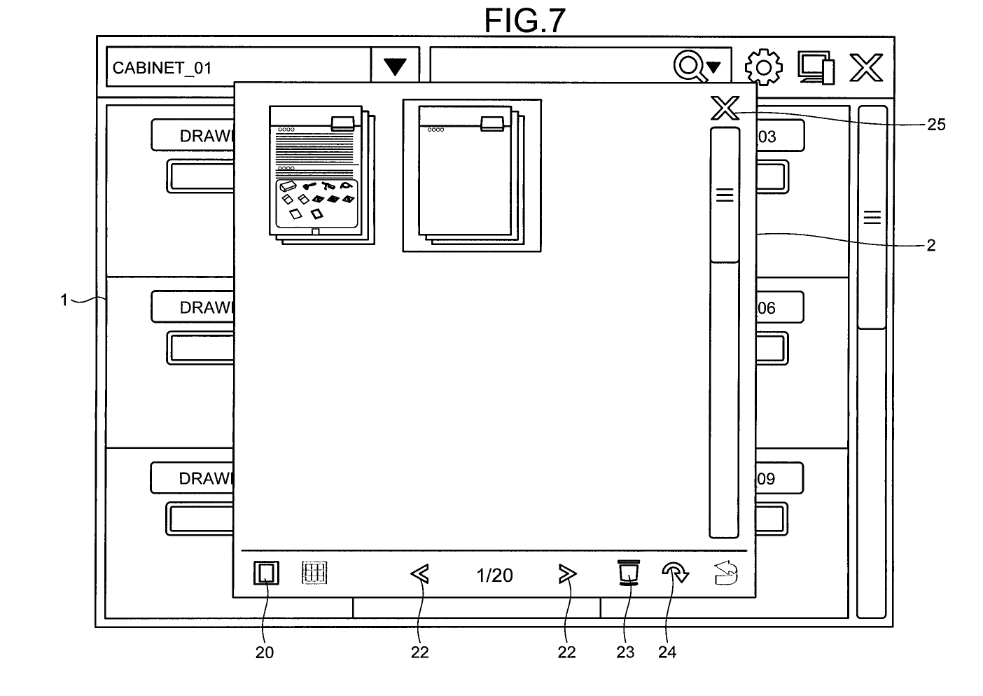

As shown in FIG. 6, when the user performs (with a finger) drag and drop operations (arrows in the figure) of thumbnails of image files onto any other thumbnail displayed on the touch panel 114 via the touch panel 114, the image displaying unit 102a detects the superimposition instruction to superimpose the thumbnails of the image files. Then, as shown in FIG. 7, the image displaying unit 102a displays on the drawer icons 1 the task window 2 in which the thumbnails of the image files are displayed in an aggregated manner.

Referring back to FIG. 3, when the user performs a drag operation to directly move an image file from the task window 2 onto any of the drawer icons 1 on the background via the touch panel 114, the display mode changing unit 102b detects an input of the image selection instruction (Step SB-4).

The display mode changing unit 102b deactivates the task window 2 (translucent display) so that the drawer icon 1 can be viewed (Step SB-5). The display mode changing unit 102b may display the task window 2 by moving the task window 2 based on an input position of the drag operation on the touch panel 114 to a position not overlapping the display of the drawer icon 1 at the input position. For example, the display mode changing unit 102b may move the task window 2 upward, downward, to the left, or to the right to a position where selection of the drawer icon 1 is not interfered, and after the drawer icon 1 is selected, move the task window 2 back to the original position. Furthermore, the display mode changing unit 102b may change the task window 2 to a minimized icon, and display the minimized icon.

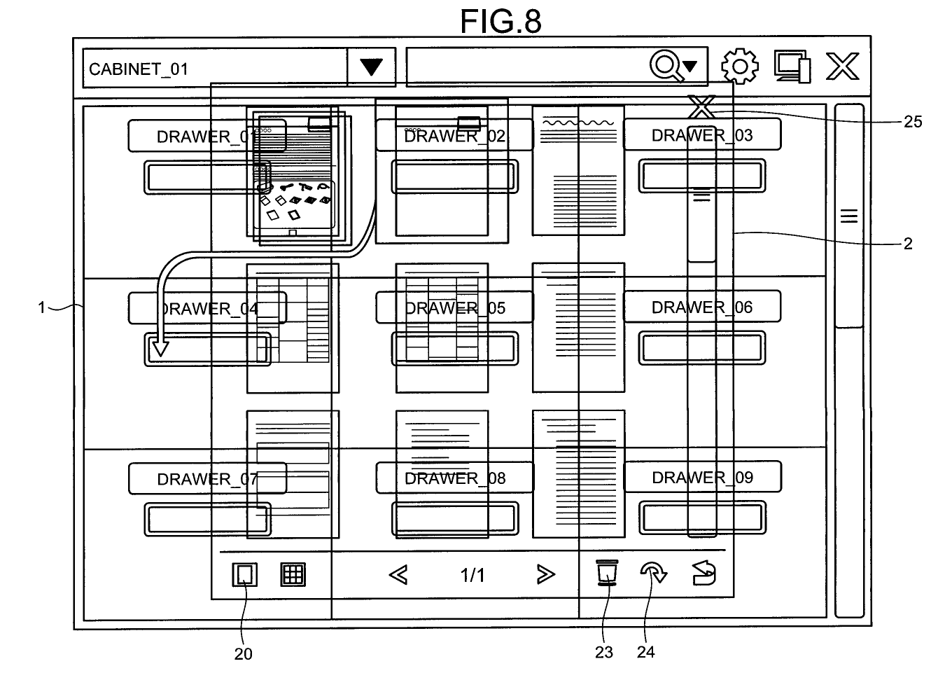

An example of deactivation of the task window 2 displayed on the touch panel 114 according to the embodiment is explained below. FIG. 8 is a diagram of an example of the display screen according to the embodiment.

As shown in FIG. 8, when the user touches any of the thumbnails on the task window 2 via the touch panel 114 and performs a drag operation (an arrow in the figure) on one of the drawer icons 1 on the background, the display mode changing unit 102b detects an input of the image selection instruction, and translucently displays the task window 2 displaying the thumbnails.

Referring back to FIG. 3, the control unit 102 detects the drawer icon 1 on which the user performs the drag operation via the touch panel 114 (Step SB-6).

The control unit 102 determines whether the user performs the selection maintaining operation of the image file via the touch panel 114, i.e., whether the drag operation is maintained for a predetermined period of time, on the drawer icon 1 detected at Step SB-6 (Step SB-7). Here, the selection maintaining operation may be an operation of, for example, maintaining finger touching on the drawer icon 1 selected as the storage destination.

When determining at Step SB-7 that the selection maintaining operation of the image file is not performed by the user via the touch panel 114 (NO at Step SB-7), the control unit 102 causes the processing to proceed to Step SB-3.

On the other hand, when the control unit 102 determines at Step SB-7 that the selection maintaining operation of the image file is performed by the user via the touch panel 114 (YES at Step SB-7), the storage location determining unit 102d determines a storage location (drawer) stored in the storage-location-information storage unit 106a for the image file (Step SB-8).

When an additional storage location stored in the storage-location-information storage unit 106a is present in a hierarchy under the storage location (drawer) determined by the storage location determining unit 102d, the hierarchy displaying unit 102f displays on the touch panel 114 a folder icon 3 representing the contents (folders) of a drawer representing the additional storage location (Step SB-9).

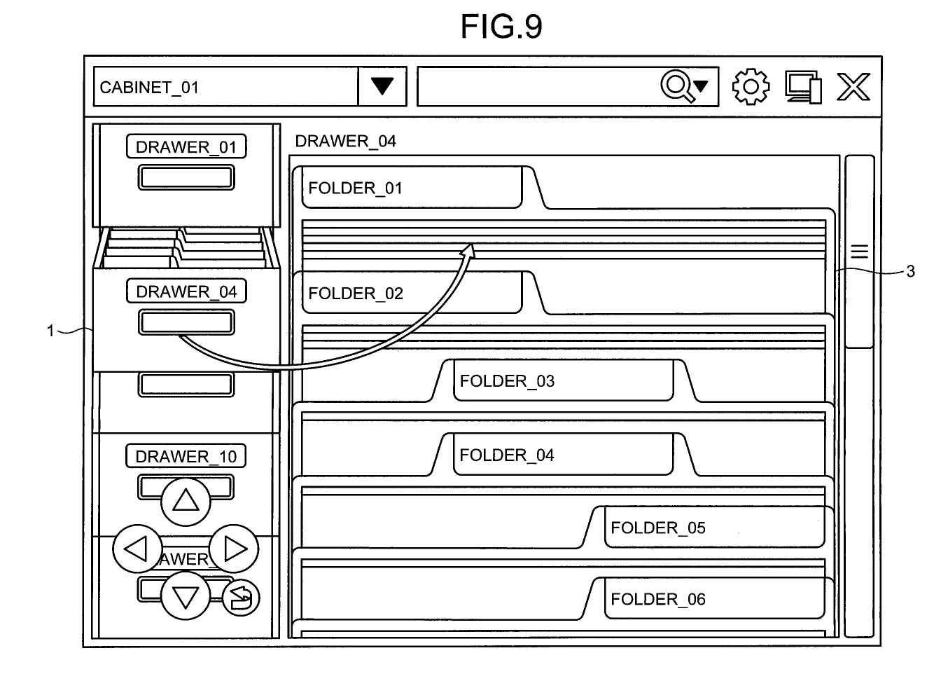

An example of a hierarchy display displayed on the touch panel 114 according to the embodiment is explained below with reference to FIG. 9. FIG. 9 is a diagram of an example of the display screen according to the embodiment.

As shown in FIG. 9, the hierarchy displaying unit 102f displays on the touch panel 114 an image in which a drawer is opened such that the contents of the drawer (i.e., folders representing a hierarchy under the drawer) are displayed. It may be possible that the contents of the drawer are sorted by the folders so that when the user moves his/her finger to the folder icon 3 corresponding to a specified folder (e.g., a folder_01) and performs a drop operation (an arrow in the figure), the image can be stored in this folder. In FIG. 9, the amount (the number) of documents displayed in the folder icon 3 may be displayed in proportion to the amount of data stored in the folder corresponding to the folder icon 3. When the list of the drawers or the contents of the drawer cannot be housed in one screen (e.g., when ten or more drawers are present), a screen may be scrolled by maintaining finger touching at the edge of the screen.

Referring back to FIG. 3, when the user performs a drag operation and a selection maintaining operation of an image file on the folder icon 3 via the touch panel 114, the storage location determining unit 102d detects the icon selection instruction to select the folder icon 3, and determines a storage location (folder) stored in the storage-location-information storage unit 106a for the image file. Furthermore, when the user performs a drop operation of the image file on the folder icon 3 via the touch panel 114, the image storing unit 102e detects an input of the storing instruction for the image file, and stores (saves) the image file in the storage location (folder) determined by the storage location determining unit 102d and corresponding to the folder icon 3 (Step SB-10). For example, when the user releases his/her finger from the folder as the storage location to drop the image file via the touch panel 114, the image storing unit 102e stores the image file in the selected folder. When a plurality of image files is to be stored, the user may select the image files one by one and store each image file by performing drag and drop onto the folder icon 3. Furthermore, the user may superimpose the image files onto any one of the image files on the task window 2 by performing drag and drop with his/her finger, and then stores the superimposed image files by performing drag and drop with his/her finger onto the folder icon 3.

The control unit 102 determines whether any image files are remained on the task window 2 (Step SB-11).

When determining at Step SB-11 that any image files are remained in the task window 2 (YES at Step SB-11), the control unit 102 causes the processing to proceed to Step SB-3. That is, after the user stores the image file by the drop operation, the task window 2 is reactivated and displayed at the frontmost in such a state that the image file stored by drag and drop is removed from the task window 2. The task window 2 is displayed as long as any images are remained on the task window 2.

On the other hand, when determining at Step SB-11 that no image file is remained on the task window 2 (NO at Step SB-11), the control unit 102 deletes the display of the task window 2 from the touch panel 114 (Step SB-12), and ends the processing. That is, when all of the images are removed from the task window 2, the task window 2 is not displayed (removed).

### Other Embodiment

The embodiment of the present invention is explained above. However, the present invention may be implemented in various different embodiments other than the embodiment described above within a technical scope described in claims.

For example, an example in which the image reading apparatus 100 performs the processing as a standalone apparatus is explained. However, the image reading apparatus 100 can be configured to perform processes in response to request from the information processing apparatus according to the embodiment (having a housing separate from the image reading apparatus 100) and return the process results to the information processing apparatus. Here, the image reading apparatus 100 may be structured by connecting any peripheral devices (e.g., image scanners) to the information processing apparatus such as known personal computers or workstations. Furthermore, the image reading apparatus 100 may be realized by mounting software (including programs, data, or the like) for causing the information processing apparatus to implement the method of the invention.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the image reading apparatus 100 are merely conceptual and may not necessarily physically resemble the structures shown in the drawings.

For example, the process functions performed by each device of the image reading apparatus 100, especially the each process function performed by the control unit 102, can be entirely or partially realized by CPU and a computer program executed by the CPU or by a hardware using wired logic. The computer program, recorded on a recording medium to be described later, can be mechanically read by the image reading apparatus 100 as the situation demands. In other words, the storage unit 106 such as read-only memory (ROM) or hard disk drive (HDD) stores the computer program that can work in coordination with an operating system (OS) to issue commands to the CPU and cause the CPU to perform various processes. The computer program is first loaded to the random access memory (RAM), and forms the control unit in collaboration with the CPU.

Alternatively, the computer program can be stored in any application program server connected to the information processing apparatus and the image reading apparatus 100 via the network, and can be fully or partially loaded as the situation demands.

The computer program may be stored in a computer-readable recording medium, or may be structured as a program product. Here, the “recording medium” includes any “portable physical medium” such as a memory card, a USB (Universal Serial Bus) memory, an SD (Secure Digital) card, a flexible disk, an optical disk, a ROM, an EPROM (Erasable Programmable Read Only Memory), an EEPROM (Electronically Erasable and Programmable Read Only Memory), a CD-ROM (Compact Disk Read Only Memory), an MO (Magneto-Optical disk), a DVD (Digital Versatile Disk), and a Blue-ray Disc.

Computer program refers to a data processing method written in any computer language and written method, and can have software codes and binary codes in any format. The computer program can be a dispersed form in the form of a plurality of modules or libraries, or can perform various functions in collaboration with a different program such as the OS. Any known configuration in the each device according to the embodiment can be used for reading the recording medium. Similarly, any known process procedure for reading or installing the computer program can be used.

Various databases (the storage-location-information storage unit 106a) stored in the storage unit 106 is a storage unit such as a memory device such as a RAM or a ROM, a fixed disk device such as a HDD, a flexible disk, and an optical disk, and stores therein various programs, tables, databases, and web page files used for providing various processing or web sites.

The information processing apparatus may be structured as known personal computers or workstations. Furthermore, the information processing apparatus may be structured by connecting any peripheral devices.

The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

According to the present invention, it is possible to intuitively and easily store the scanned image in a desired storage destination.

According to the present invention, even when a storage location icon in a portion overlapping the image display area is not viewable despite the fact that the image display area, such as a task window, is smaller than the storage location icon, because the image display area is translucent, the storage location icon on the background can be viewed in a selectable state.

According to the present invention, when a user touches and drags an image file with his/her finger onto the storage location icon on the background, the image display area is moved upward, downward, to the left, or to the right, so that a storage destination screen on the background can be viewed in a selectable state.

According to the present invention, all of the storage location icons including those in a portion hidden by the image display area displayed in a superimposed manner can be viewed in a selectable state.

According to the present invention, it is possible to precisely define storing processing.

According to the present invention, when a plurality of folders in a multistage hierarchical structure is generated in a storage area, a folder at a low level in the hierarchical structure can be selected as a storage destination by only an intuitive operation on the touch panel.

According to the present invention, the image file can be selected by an intuitive and easy operation on the touch panel.

According to the present invention, the storage location of the image file can be selected by an intuitive and easy operation on the touch panel.

According to the present invention, the image file can be stored by an intuitive and easy operation on the touch panel.

According to the present invention, the image files as data can be organized intuitively and easily on the touch panel like that paper documents are bundled.

According to the present invention, the display format can be changed by only a button operation.

According to the present invention, the display format can be changed by only a button operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
an image reading unit, a touch panel, a storage unit, and a control unit, wherein
the storage unit includes:
a storage-location-information storage unit that stores storage location information related to a storage location of an image file of a document read by the image reading unit, and
the control unit includes:
an image displaying unit that displays, on the touch panel, a storage location icon representing the storage location and an image display area showing the image file;
a display mode changing unit that changes, when an image selection instruction to select the image file is input via the touch panel, a display mode of the image display area so that the storage location icon can be viewed; and
a storing unit that stores, when an icon selection instruction to select the storage location icon is input via the touch panel, the image file in the storage location corresponding to the storage location icon.

2. The image reading apparatus according to claim 1, wherein
when the image selection instruction to select the image file is input via the touch panel, the display mode changing unit translucently displays the image display area.

3. The image reading apparatus according to claim 1, wherein
when the image selection instruction to select the image file is input via the touch panel, the display mode changing unit displays the image display area by moving the image display area based on an input position of the image selection instruction on the touch panel to a position not overlapping a display of the storage location icon at the input position.

4. The image reading apparatus according to claim 1, wherein
when the image selection instruction to select the image file is input via the touch panel, the display mode changing unit changes the image display area to a minimized icon, and displays the minimized icon.

5. The image reading apparatus according to claim 1, wherein
the storing unit further includes:
a storage location determining unit that determines, when the icon selection instruction to select the storage location icon is input via the touch panel, a storage location of the image file; and
an image storing unit that stores, when a storing instruction for the image file is input via the touch panel, the image file in the storage location determined by the storage location determining unit.

6. The image reading apparatus according to claim 5, wherein
the control unit further includes:
a hierarchy displaying unit that displays, when an additional storage location is present in a hierarchy under the storage location determined by the storage location determining unit, a storage location icon representing the additional storage location on the touch panel.

7. The image reading apparatus according to claim 1, wherein
the image selection instruction is given by a drag operation of the image file onto the storage location icon.

8. The image reading apparatus according to claim 1, wherein
the icon selection instruction is given by a selection maintaining operation of the image file on the storage location icon.

9. The image reading apparatus according to claim 5, wherein
the storing instruction is given by a drop operation of the image file onto the storage location icon.

10. The image reading apparatus according to claim 1, wherein
the image displaying unit displays, on the touch panel, when a superimposition instruction to superimpose the image file onto any other image file is input via the touch panel, the storage location icon and the image display area, wherein
the image files are displayed in an aggregated manner.

11. The image reading apparatus according to claim 1, wherein
the image displaying unit displays, on the touch panel, when an aggregation display instruction to display an aggregation view of image files being displayed as a list is input via the touch panel, the storage location icon and the image display area, wherein
the image files having been displayed as a list are displayed in an aggregated manner.

12. The image reading apparatus according to claim 1, wherein
the image displaying unit displays, on the touch panel, when a list display instruction to display a list view of image files being displayed in an aggregated manner is input via the touch panel, the storage location icon and the image display area, wherein
the image files having been displayed in an aggregated manner is displayed as a list.

13. An information processing apparatus connected to an image reading apparatus,
the information processing apparatus comprising:
a touch panel, a storage unit, and a control unit, wherein
the storage unit includes:
a storage-location-information storage unit that stores storage location information related to a storage location of an image file of a document read by the image reading unit, and
the control unit includes:
an image displaying unit that displays, on the touch panel, a storage location icon representing the storage location and an image display area showing the image file;
a display mode changing unit that changes, when an image selection instruction to select the image file is input via the touch panel, a display mode of the image display area so that the storage location icon can be viewed; and
a storing unit that stores, when an icon selection instruction to select the storage location icon via the touch panel, the image file in the storage location corresponding to the storage location icon.

14. An image processing method executed by an image reading apparatus including:
an image reading unit, a touch panel, a storage unit, and a control unit, wherein
the storage unit includes:
a storage-location-information storage unit that stores storage location information related to a storage location of an image file of a document read by the image reading unit,
the method comprising:
an image displaying step of displaying, on the touch panel, a storage location icon representing the storage location and an image display area showing the image file;
a display mode changing step of changing, when an image selection instruction to select the image file is input via the touch panel, a display mode of the image display area so that the storage location icon can be viewed; and
a storing step of storing, when an icon selection instruction to select the storage location icon is input via the touch panel, the image file in the storage location corresponding to the storage location icon, wherein
the steps are executed by the control unit.

15. An image processing method executed by an information processing apparatus connected to an image reading apparatus, wherein the information processing apparatus includes:
a touch panel, a storage unit, and a control unit, wherein
the storage unit includes:
a storage-location-information storage unit that stores storage location information related to a storage location of an image file of a document read by the image reading unit,
the method comprising:
an image displaying step of displaying, on the touch panel, a storage location icon representing the storage location and an image display area showing the image file;
a display mode changing step of changing, when an image selection instruction to select the image file is input via the touch panel, a display mode of the image display area so that the storage location icon can be viewed; and
a storing step of storing, when an icon selection instruction to select the storage location icon is input via the touch panel, the image file in the storage location corresponding to the storage location icon, wherein
the steps are executed by the control unit.

16. A computer program product having a computer readable medium including programmed instructions for an image processing method executed by an image reading apparatus including: an image reading unit, a touch panel, a storage unit, and a control unit, wherein
the storage unit includes:
a storage-location-information storage unit that stores storage location information related to a storage location of an image file of a document read by the image reading unit,
the instructions, when executed by a computer, cause the computer to execute:
an image displaying step of displaying, on the touch panel, a storage location icon representing the storage location and an image display area showing the image file;
a display mode changing step of changing, when an image selection instruction to select the image file is input via the touch panel, a display mode of the image display area so that the storage location icon can be viewed; and
a storing step of storing, when an icon selection instruction to select the storage location icon is input via the touch panel, the image file in the storage location corresponding to the storage location icon, wherein
the steps are executed by the control unit.

17. A computer program product having a computer readable medium including programmed instructions for an image processing method executed by an information processing apparatus connected to an image reading apparatus, wherein the information processing apparatus includes:
an image reading unit, a touch panel, a storage unit, and a control unit, wherein
the storage unit includes:
a storage-location-information storage unit that stores storage location information related to a storage location of an image file of a document read by the image reading unit,
the instructions, when executed by a computer, cause the computer to execute:
an image displaying step of displaying, on the touch panel, a storage location icon representing the storage location and an image display area showing the image file;
a display mode changing step of changing, when an image selection instruction to select the image file is input via the touch panel, a display mode of the image display area so that the storage location icon can be viewed; and
a storing step of storing, when an icon selection instruction to select the storage location icon is input via the touch panel, the image file in the storage location corresponding to the storage location icon, wherein
the steps are executed by the control unit.
